(19) United States
(12) Patent Application Publication
(10) Pub. No.: US 2026/0100465 A1
(43) Pub. Date: Apr. 9, 2026

(54) TRACTION BATTERY PACK CELL STACK DESIGNS FOR ESTABLISHING SEALED INTERFACES

(71) Applicant: FORD GLOBAL TECHNOLOGIES, LLC, Dearborn, MI (US)

(72) Inventors: Mohammadreza Eftekhari, Novi, MI (US); Deanna Marie Winton Hoffman, Ann Arbor, MI (US); Joseph Benson, Fenton, MI (US)

(21) Appl. No.: 18/906,425

(22) Filed: Oct. 4, 2024

(51) Int. Cl. H01M 50/262; B60L 50/64; H01M 10/625; H01M 10/658; H01M 50/211; H01M 50/249; H01M 50/271

(52) U.S. Cl. CPC H01M 50/262; B60L 50/64; H01M 10/625; H01M 10/658; H01M 50/211; H01M 50/249; H01M 50/271; H01M 2220/20

(57) ABSTRACT

Battery cell stack designs are provided for traction battery packs. An exemplary traction battery pack may include one or more cell stacks housed within an enclosure assembly. Each cell stack may include a top cover and a thermal barrier assembly. The top cover is arranged to protect and interface with an enclosure cover of the enclosure assembly, and the thermal barrier assembly is arranged to inhibit the transfer of thermal energy across the cell stack. A first adhesive may secure a portion of the thermal barrier assembly to the top cover, and a second adhesive may secure the top cover to the enclosure assembly, thereby structurally integrating the traction battery pack.

### TECHNICAL FIELD

This disclosure relates generally to traction battery packs, and more particularly to cell stack designs that facilitate establishing sealed interfaces relative to surrounding structures.

### BACKGROUND

Electrified vehicles include a traction battery pack for powering electric machines and other electrical loads of the vehicle. The traction battery pack includes a plurality of battery cells that store energy for supporting electric vehicle propulsion.

### SUMMARY

A traction battery pack according to an exemplary aspect of the present disclosure includes, among other things, a cell stack including a top cover and a thermal barrier assembly. A groove is formed in the top cover, and a structural barrier of the thermal barrier assembly is received within the groove. A first adhesive secures the structural barrier within the groove.

In a further non-limiting embodiment of the foregoing traction battery pack, the structural barrier is a pultrusion.

In a further non-limiting embodiment of either of the foregoing traction battery packs, the structural barrier is flanked by a pair of thermal resistance material layers to establish a multi-layer sandwich structure of the thermal barrier assembly.

In a further non-limiting embodiment of any of the foregoing traction battery packs, the cell stack is housed within an interior area provided by an enclosure assembly of the traction battery pack.

In a further non-limiting embodiment of any of the foregoing traction battery packs, a second adhesive secures the top cover to an enclosure cover of the enclosure assembly.

In a further non-limiting embodiment of any of the foregoing traction battery packs, the first adhesive is a structural adhesive, and the second adhesive is an expandable foam adhesive.

In a further non-limiting embodiment of any of the foregoing traction battery packs, a fastener secures the top cover and the enclosure cover together. The fastener is secured by a nut provided at an inner wall of the top cover.

In a further non-limiting embodiment of any of the foregoing traction battery packs, the groove is formed in a rib of the top cover.

In a further non-limiting embodiment of any of the foregoing traction battery packs, the structural barrier includes a ledge having a collection surface adapted for catching a portion of the first adhesive that drips out of the groove.

In a further non-limiting embodiment of any of the foregoing traction battery packs, the top cover is made of a composite material.

A traction battery pack according to another exemplary aspect of the present disclosure includes, among other things, an enclosure assembly that provides an interior area, a cell stack housed within the interior area and including a top cover and a thermal barrier assembly, a first adhesive that secures the thermal barrier assembly to the top cover, and a second adhesive that secures the top cover to the enclosure assembly.

In a further non-limiting embodiment of the foregoing traction battery pack, the first adhesive is received within a groove formed in the top cover.

In a further non-limiting embodiment of either of the foregoing traction battery packs, the groove is formed in a rib of the top cover.

In a further non-limiting embodiment of any of the foregoing traction battery packs, the first adhesive is a structural adhesive that secures a structural barrier of the thermal barrier assembly within the groove.

In a further non-limiting embodiment of any of the foregoing traction battery packs, the structural barrier is a pultrusion.

In a further non-limiting embodiment of any of the foregoing traction battery packs, the structural barrier includes a ledge having a collection surface adapted for catching a portion of the first adhesive that drips out of the groove.

In a further non-limiting embodiment of any of the foregoing traction battery packs, the second adhesive is applied between the top cover and an enclosure cover of the enclosure assembly.

In a further non-limiting embodiment of any of the foregoing traction battery packs, the second adhesive is an expandable foam adhesive.

In a further non-limiting embodiment of any of the foregoing traction battery packs, a fastener secures the top cover and an enclosure cover of the enclosure assembly together. The fastener is secured by a nut provided at an inner wall of the top cover.

In a further non-limiting embodiment of any of the foregoing traction battery packs, the top cover is made of a composite material.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 is a cross-sectional view of select portions of a cell stack of a traction battery pack.

FIG. 4 is a cross-sectional view of select portions of another exemplary cell stack of a traction battery pack.

### DETAILED DESCRIPTION

This disclosure details battery cell stack designs for traction battery packs. An exemplary traction battery pack may include one or more cell stacks housed within an enclosure assembly. Each cell stack may include a top cover and a thermal barrier assembly. The top cover is arranged to protect and interface with an enclosure cover of the enclosure assembly, and the thermal barrier assembly is arranged to inhibit the transfer of thermal energy across the cell stack. A first adhesive may secure a portion of the thermal barrier assembly to the top cover, and a second adhesive may secure the top cover to the enclosure assembly, thereby structurally integrating the traction battery pack. These and other features are discussed in greater detail in the following paragraphs of this detailed description.

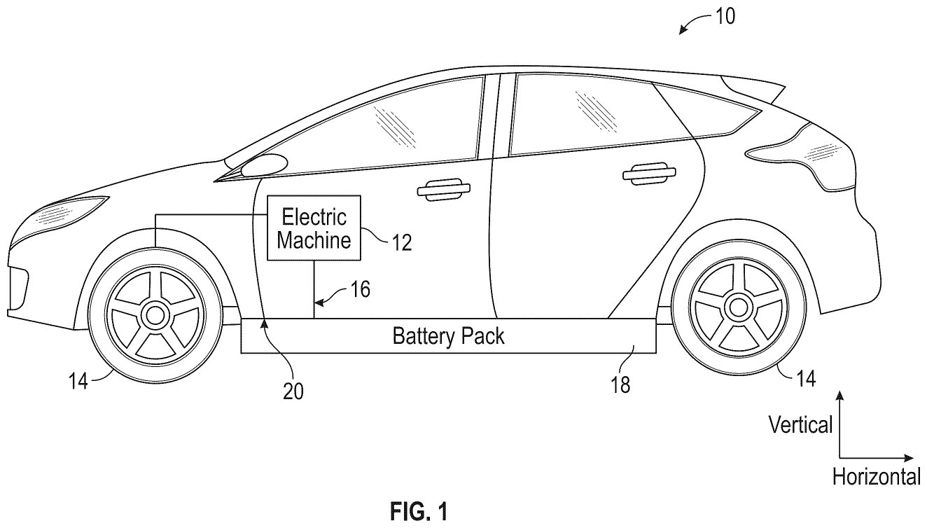

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

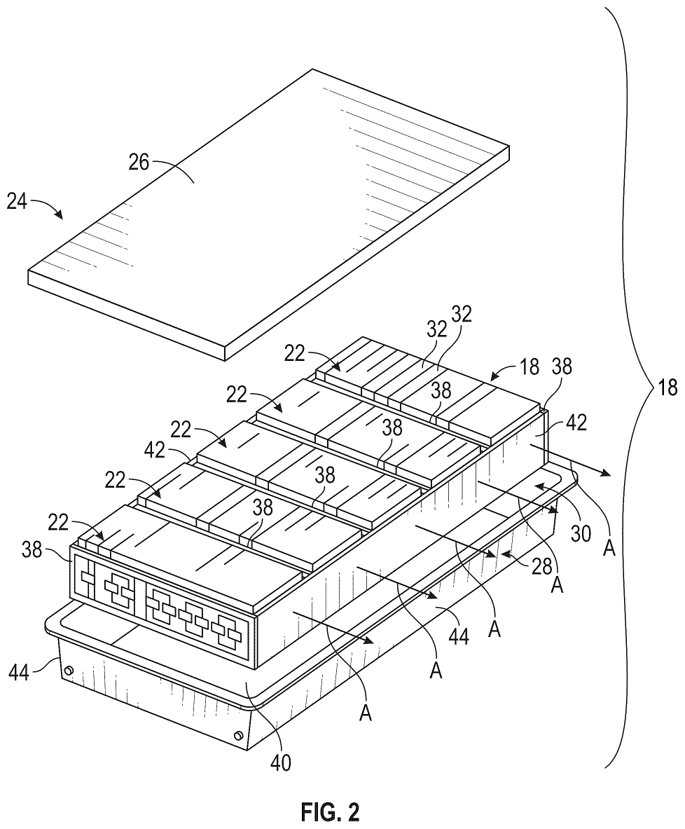

FIG. 2 illustrates additional details associated with the traction battery pack 18 of the electrified vehicle 10 of FIG. 1. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18. The enclosure cover 26 and the enclosure tray 28 therefore provide the outermost surfaces of the traction battery pack 18.

Each cell stack 22 may include a plurality of battery cells 32. The battery cells 32 of each cell stack 22 may be stacked together side-by-side to one another along a cell stack axis A. The battery cells 32 store and supply electrical power for powering various components of the electrified vehicle 10. Although a specific number of the cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The exemplary battery cells 32 can include tab terminals that project outwardly from a battery cell housing. The tab terminals of the battery cells 32 of each cell stack 22 are connected to one another, such as by one or more busbars, for example, in order to provide the voltage and power levels necessary for achieving electric vehicle propulsion.

The battery cells 32 of each cell stack 22 may be arranged between a pair of cross-member assemblies 38. Among other functions, the cross-member assemblies 38 may be configured to hold the battery cells 32 and at least partially delineate the cell stacks 22 from one another within the interior area 30 of the enclosure assembly 24.

Each cross-member assembly 38 may be configured to transfer a load applied to a side of the electrified vehicle 10, for example, for ensuring that the battery cells 32 do not become overcompressed. Each cross-member assembly 38 may be further configured to accommodate tension loads resulting from expansion and retraction of the battery cells 32. The cross-member assemblies 38 described herein are therefore configured to increase the structural integrity of the traction battery pack 18.

A vertically upper side of each cell stack 22 may interface with the enclosure cover 26, and a vertically lower side of each cell stack 22 may interface with a heat exchanger plate 40 that is positioned against a floor of the enclosure tray 28. A thermal interface material 70 (e.g., epoxy resin, silicone based materials, thermal greases, etc.) may be disposed between the battery cells 32 of the cell stack 22 and the heat exchanger plate 40 for facilitating heat transfer therebetween.

In another embodiment, the heat exchanger plate 40 may be omitted and the vertically lower side of each cell stack 22 may be received in direct contact with the floor of the enclosure tray 28. Vertical and horizontal, for purposes of this disclosure, are with reference to ground and a general orientation of traction battery pack 18 when installed on the electrified vehicle 10 of FIG. 1.

The cross-member assemblies 38 may be adhesively secured to the enclosure cover 26 and to either the heat exchanger plate 40 or the enclosure tray 28 to seal the interfaces between these neighboring components and to structurally integrate the traction battery pack 18.

The traction battery pack 18 may additionally include a pair of structural plate members 42. One structural plate member 42 may be positioned between ends of the cell stacks 22 and each longitudinally extending side wall 44 of the enclosure tray 28, for example. The structural plate members 42 may extend along axes that are substantially transverse (e.g. perpendicular) to the cell stack axes A of the cell stacks 22 and to the cross-member assemblies 38. The structural plate members 42 can span across a majority of the length of the longitudinally extending side walls 44 of the enclosure tray 28 and can thus be referred to as structural “megabars” of the traction battery pack 18. However, other configurations are contemplated within the scope of this disclosure.

In an embodiment, the cell stacks 22 and the cross-member assemblies 38 extend longitudinally in a cross-vehicle direction of the electrified vehicle 10, and the structural plate members 42 extend longitudinally in a length-wise direction of the electrified vehicle 10. However, other configurations are contemplated within the scope of this disclosure.

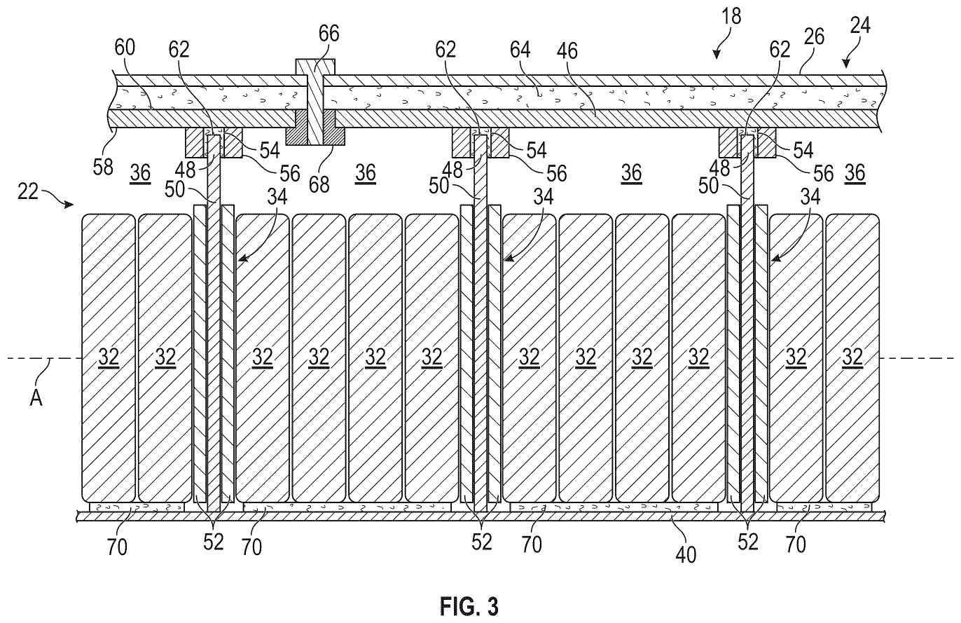

Referring now to FIG. 3, with continued reference to FIGS. 1-2, one or more thermal barrier assemblies 34 may be arranged along the respective cell stack axis A of each cell stack 22. The thermal barrier assemblies 34 may compartmentalize each cell stack 22 into two or more groupings or compartments 36 of battery cells 32. Each compartment 36 may hold one or more of the battery cells 32 of the cell stack 22. In an embodiment, groups of four individual battery cells 32 are separated by thermal barrier assemblies 34 along the cell stack axis A of the cell stack 22. However, other configurations are contemplated within the scope of this disclosure.

Should, for example, a battery thermal event occur in one or more battery cells 32 of the cell stack 22, the structural thermal barrier assemblies 34 may reduce or even prevent thermal energy associated with the thermal event from moving from cell-to-cell, compartment-to-compartment, and/or cell stack-to-cell stack, thereby inhibiting the transfer of thermal energy inside the traction battery pack 18. As further explained below, the thermal barrier assemblies 34 may be adhesively secured to surrounding structures for increasing the structural integrity of the traction battery pack 18.

Each thermal barrier assembly 34 of the cell stack 22 may include a structural barrier 50 that is flanked by pairs of thermal resistance material layers 52 as part of a multi-layered structure of the thermal barrier assembly 34. The structural barrier 50 may be sandwiched between the thermal resistance material layers 52, for example. The thermal resistance material layers 52 can be positioned in abutting contact with major side surfaces of battery cells 32 located in adjacent compartments 36 of the cell stack 22.

The structural barrier 50 may include a thermoplastic structure or a polymer composite structure (e.g., glass fiber reinforced polypropylene with an intumescent additive), for example, and the thermal resistance material layers 52 may include aerogel layers or mica sheets, for example. However, other materials or combinations of materials could be utilized to construct the subcomponents of the thermal barrier assembly 34 within the scope of this disclosure.

The structural barrier 50 of the thermal barrier assembly 34 may be a pultrusion, which implicates structure to this component. A person of ordinary skill in the art having the benefit of this disclosure would understand how to structurally distinguish a pultruded structure from another type of structure, such as an extrusion, for example. The structural barrier 50 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the structural barrier 50. In other implementations, the structural barrier 50 could be an injection molded part or an extruded part.

Each cell stack 22 of the traction battery pack 18 may additionally include a top cover 46 that is arranged vertically above the grouping of battery cells 32 of the cell stack 22. The top cover 46 may shield the enclosure cover 26 from thermal energy originating from one or more battery cells 32 of the cell stack 22, either during normal battery operating conditions or during battery thermal events.

The top cover 46 may be made of a composite material. The composite material may be a thermally resistant composite material.

The top cover 46 of the cell stack 22 may include a plurality of grooves 54. The grooves 54 may be formed into the top cover 46. In an embodiment, each groove 54 is formed in a rib 56 of the top cover 46. The rib 56 may be an area of increased thickness that protrudes inwardly from an inner wall 58 of the top cover 46, for example. In another embodiment, each groove 54 may be formed in the inner wall 58 at a non-thickened section of the top cover 46. Each groove 54 may extend into the top cover 46 in a direction toward an outer wall 60 of the top cover 46. The inner wall 58 faces toward the battery cells 32, and the outer wall 60 faces toward the enclosure cover 26.

Each groove 54 may provide an open space in the top cover 46 for accommodating the structural barrier 50 of one of the thermal barrier assemblies 34 of the cell stack 22. For example, an upper portion 48 of each structural barrier 50 may be accommodated within each respective groove 54. The upper portions 48 extend vertically above top surfaces of the battery cells 32 of the cell stack 22.

The upper portion 48 of the structural barrier 50 may include a plane shape. In an embodiment, the plane shape is rectangular. The plane shapes of the upper portions 48 provide smaller peak stresses than non-plane shapes and thus, when used in combination with the grooves 54, enable increased structural and thermal performance.

The locations and sizes (e.g., width and depth) of the grooves 54 may depend on factors such as the clearance distances between the top cover 46 and the battery cells 32, structural and thermal performance requirements of the cell stack 22, assembly and manufacturing feasibility of the cell stack 22, etc.

A first adhesive 62 may be disposed within each groove 54 for structurally joining the structural barriers 50 to the top cover 46 and thereby increasing the structural integrity of the cell stack 22. The first adhesive 62 may be a structural adhesive such as an epoxy based adhesive or a urethane based adhesive, for example. By joining the structural barriers 50 to the top cover 46 via the grooves 54 and the first adhesive 62, the contact area between the top cover 46 and the structural barriers 50 is increased, thereby increasing heat transfer between the top cover 46 and the thermal barrier assemblies 34. Moreover, the first adhesive 62 functions to seal the compartments 36 from one another, thereby substantially inhibiting the transfer of thermal energy from one compartment 36 to another across the length of the cell stack 22.

Due at least in part to the plane shape of the upper portion 48 of the structural barriers 50, the first adhesive 62 may contact each structural barrier 50 along three faces (e.g., opposing sides and top). The first adhesive 62 will thus mainly carry shear forces (e.g., those acting in the vertical or Z-axis direction) as opposed to peel forces (e.g., those acting in the horizontal or X-axis direction), which may preserve the integrity of the adhesion during shock and vibration.

A second adhesive 64 may be disposed between the top cover 46 of each cell stack 22 and the enclosure cover 26 for structurally integrating the cell stacks 22 with the enclosure assembly 24 of the traction battery pack 18. The second adhesive 64 may either substantially fill the entire void space between the enclosure cover 26 and the cell stack 22 or only select portions therebetween. The second adhesive 64 may be an expandable foam adhesive, for example.

The enclosure cover 26 may be made of either the same material or a different material than the top cover 46 of the cell stack 22. In an embodiment, the enclosure cover 26 is made of a composite material. In another embodiment, the enclosure cover 26 is made of a metallic material (e.g., e-coated steel, etc.). However, other materials are contemplated within the scope of this disclosure.

Once the structural barriers 50 are joined to the top cover 46 and the top cover 46 is joined to the enclosure cover 26, the cell stack 22 and the enclosure assembly 24 are effectively structurally coupled to one another. The proposed cell stack designs discussed herein therefore facilitate increasing the structural stiffness of the traction battery pack 18.

One or more mechanical fasteners 66 (e.g., bolts) may optionally be utilized to augment the connection between the top cover 46 and the enclosure cover 26. Each fastener 66 may be inserted through both the enclosure cover 26 and the top cover 46 and can be secured in place by a nut 68. The nut 68 may be an integral (e.g., molded) feature of the top cover 46 or could be a completely separate component that is adhesively secured to the top cover 46, for example.

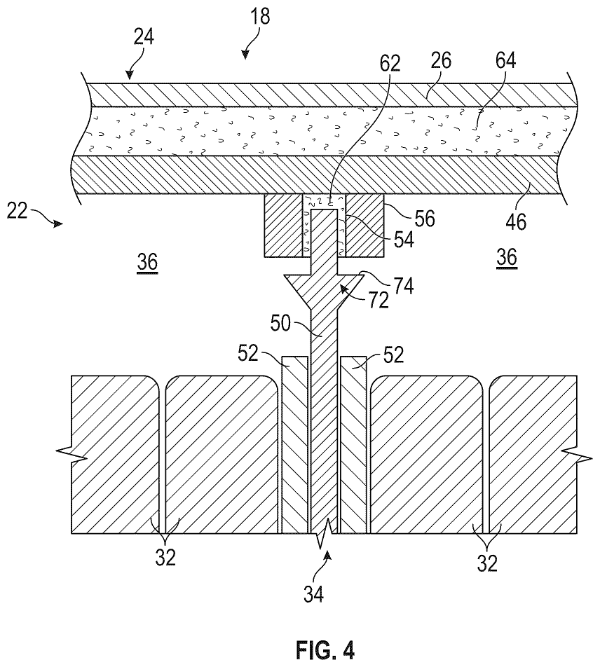

Referring now to FIG. 4, the structural barrier 50 of each thermal barrier assembly 34 may in some implementations incorporate a ledge 72 that includes a collection surface 74. The collection surface 74 can catch portions of the first adhesive 62 that could potentially drip out of grooves 54 prior to curing, thereby preventing the first adhesive 62 from dripping down onto the battery cells 32. In an embodiment, the ledge 72 is a molded-in feature of the structural barrier 50. However, other implementations are also contemplated within the scope of this disclosure.

The cell stacks of this disclosure incorporate multi-functional top covers that provide numerous advantages over prior cell stack designs. Among other benefits, the multi-functional cell stack top covers may shield the traction battery outer enclosure assembly from thermal energy, provide the ability to seal multiple surrounding structure interfaces, provide the ability to capture adhesive during curing to limit spillage onto battery cells, etc.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a cell stack including a top cover and a thermal barrier assembly;
a groove formed in the top cover;
a structural barrier of the thermal barrier assembly received within the groove; and
a first adhesive that secures the structural barrier within the groove.

2. The traction battery pack as recited in claim 1, wherein the structural barrier is a pultrusion.

3. The traction battery pack as recited in claim 2, wherein the structural barrier is flanked by a pair of thermal resistance material layers to establish a multi-layer sandwich structure of the thermal barrier assembly.

4. The traction battery pack as recited in claim 1, wherein the cell stack is housed within an interior area provided by an enclosure assembly of the traction battery pack.

5. The traction battery pack as recited in claim 4, comprising a second adhesive that secures the top cover to an enclosure cover of the enclosure assembly.

6. The traction battery pack as recited in claim 5, wherein the first adhesive is a structural adhesive, and the second adhesive is an expandable foam adhesive.

7. The traction battery pack as recited in claim 5, comprising a fastener that secures the top cover and the enclosure cover together, wherein the fastener is secured by a nut provided at an inner wall of the top cover.

8. The traction battery pack as recited in claim 1, wherein the groove is formed in a rib of the top cover.

9. The traction battery pack as recited in claim 1, wherein the structural barrier includes a ledge having a collection surface adapted for catching a portion of the first adhesive that drips out of the groove.

10. The traction battery pack as recited in claim 1, wherein the top cover is made of a composite material.

11. A traction battery pack, comprising:
an enclosure assembly that provides an interior area;
a cell stack housed within the interior area and including a top cover and a thermal barrier assembly;
a first adhesive that secures the thermal barrier assembly to the top cover; and
a second adhesive that secures the top cover to the enclosure assembly.

12. The traction battery pack as recited in claim 11, wherein the first adhesive is received within a groove formed in the top cover.

13. The traction battery pack as recited in claim 12, wherein the groove is formed in a rib of the top cover.

14. The traction battery pack as recited in claim 12, wherein the first adhesive is a structural adhesive that secures a structural barrier of the thermal barrier assembly within the groove.

15. The traction battery pack as recited in claim 14, wherein the structural barrier is a pultrusion.

16. The traction battery pack as recited in claim 14, wherein the structural barrier includes a ledge having a collection surface adapted for catching a portion of the first adhesive that drips out of the groove.

17. The traction battery pack as recited in claim 11, wherein the second adhesive is applied between the top cover and an enclosure cover of the enclosure assembly.

18. The traction battery pack as recited in claim 17, wherein the second adhesive is an expandable foam adhesive.

19. The traction battery pack as recited in claim 11, comprising a fastener that secures the top cover and an enclosure cover of the enclosure assembly together, wherein the fastener is secured by a nut provided at an inner wall of the top cover.

20. The traction battery pack as recited in claim 19, wherein the top cover is made of a composite material.
